(19) United States
(12) Patent Application Publication
(10) Pub. No.: US 2023/0351531 A1
(43) Pub. Date: Nov. 2, 2023

(54) SAFETY MANAGEMENT AND BUILDING OPERATIONAL ASSESSMENT SYSTEM AND METHOD FOR MULTIPLE OCCUPANCY BUILDINGS

(71) Applicant: QUIPEX PTY LTD, Mount Macedon (AU)

(72) Inventors: David John Graham, Mount Macedon (AU); Robert Pradolin, Mount Macedon (AU); Ki Siong Jong, Mount Macedon (AU)

(21) Appl. No.: 18/349,063

(22) Filed: Jul. 7, 2023

Related U.S. Application Data
(63) Continuation of application No. 17/596,733, filed on Dec. 16, 2021.

(30) Foreign Application Priority Data
Jun. 19, 2019 (AU) 2019902143

(51) Int. Cl. G06Q 50/16; G06Q 10/0639

(52) U.S. Cl. CPC G06Q 50/163; G06Q 10/06393; G08B 29/16

(57) ABSTRACT

Systems and methods are for performing operational assessment of a facility. An example method includes providing a facility information management server system, which includes a server system processor, a server system communication interface accessible by the server system processor, and a server system memory storing server system executable program instructions accessible by the server system processor. The example method further includes receiving a request from a client device, in which the received request indicates a facility operational assessment is to be conducted in relation to the facility. In response to the received request, the facility information management server system retrieves facility operational assessment data from a facility information repository database relating to the assessed facility. A facility operational assessment result can be determined based on the retrieved facility operational assessment data. The determined facility operational assessment result can be transmitted to the client device.

### CROSS-REFERENCE TO RELATED APPLICATIONS

This application is a continuation of U.S. application Ser. No. 17/596,733 filed on Dec. 16, 2021 as the U.S. National Phase under 35. U.S.C. § 371 of International Application PCT/AU2020/050628, filed Jun. 19, 2020, which claims priority to Australian Patent Application No. 2019902143, filed Jun. 19, 2019. The disclosures of the above-described applications are hereby incorporated by reference in their entirety.

### TECHNICAL FIELD

Embodiments generally relate to systems and methods for facility management. In particular, embodiments relate to systems and methods for facility compliance and emergency management.

### BACKGROUND

Built facilities such as office or apartment buildings, convention centres, stadiums, theatres and shopping malls provide spaces for habitation, business, recreation and a host of other activities. Often the design, construction, maintenance and organisation of facilities are subject to federal or state-mandated laws and regulations. In some contexts, facilities may be designed to conform to private certification standards, such as for example, energy efficiency standards. Depending on the location, purpose or nature of a facility, it may be subject to a particular set of standards or requirements that must be complied with during construction and/or normal operation or occupancy.

Most modern facilities are complex and have several internal systems for safety, security, emergency management, energy management, climate control, ventilation, and parking management, for example. The internal systems of facilities may also be subject to federal or state mandated and/or private regulations or compliance standards. As facilities, internal systems in facilities and the related regulations and standards grow in complexity, assessing initial conformity and ongoing compliance of facilities with all applicable regulations presents a significant technical challenge.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a facility information management server system comprising:
a server system processor;
a server system communication interface accessible by the server system processor; and
a server system memory storing server system executable program instructions accessible by the server system processor;
wherein the server system processor is configured to execute the server system program instructions to:
receive facility information from one or more facility information devices through the server system communication interface;
store the received facility information in the server system memory;
receive a request for operational assessment of a facility from a client device;
retrieve facility operational assessment data from a facility information repository database relating to the assessed facility;
determine a facility operational assessment result based on the retrieved facility operational assessment data, and
transmit the determined facility operational assessment result to the client device.

The server system processor may be further configured to execute the server system program instructions to:
determine whether the retrieved facility operational assessment data is sufficient to perform the requested facility operational assessment,
transmit a request to an assessed facility information device to retrieve further facility operational assessment data related to the assessed facility on determining that the retrieved facility operational assessment data is insufficient to perform the requested operational assessment,
receive the further facility operational assessment data from the assessed facility information device for facility operational assessment determination.

Determining the facility operational assessment result may comprise processing the retrieved facility operational assessment data and the received further facility operational assessment data by a facility operational assessment decision tree implemented by the server system processor based on code stored in the server system memory.

Determining the facility operational assessment result may comprise processing the retrieved facility operational assessment data and the received further facility operational assessment data by a facility operational assessment scoring module implemented in the server system memory.

The facility operational assessment data may comprise one or more of: facility fire indicator panel data, facility occupant warning system data, facility lift control system data, facility water supply system data, facility active fire safety component data, facility passive fire safety component data, facility smoke hazard management system data, facility sprinkler control system data, facility electricity systems data, facility heating ventilation and air conditioning (HVAC) system data, and facility compliance standards data.

The facility operational assessment result may comprise a facility operational assessment numeric score and/or a facility operational assessment grade.

The facility operational assessment request may comprise one or more request parameters, the one or more request parameters comprising instructions to perform the facility operational assessment over a requested period of time or to perform facility operational assessment relating to a subset of facility operations.

Some embodiments relate to a facility information management server system, wherein each of the one or more facility information devices is housed inside an internal cavity in a post positioned in a location spaced from but proximate to a facility to which the facility information pertains, wherein the post is fixed in position and is accessible to pedestrians at ground level, wherein each of the one or more facility information devices comprises:
a processor;
a communication interface accessible by the processor and configured to allow exchange of information with devices external of the post; and
a memory storing executable program instructions accessible by the processor.

The processor of the facility information device may be configured to execute program instructions to:
receive facility information from an external computing device through the communication interface, wherein the facility information relates to the facility;
store the received facility information in the memory;
receive a first request to access the facility information through the communication interface; and
in response to the first request, determine whether the first request is an authorised request and, if the first request is an authorised request, transmit the facility information through the communication interface.

In some embodiments, the server system processor is configured to execute the server system program instructions to: receive a request from the client device to store a digital document in any one of the one or more facility information devices, the request comprising the digital document; and process the received digital document to determine completeness and/or validity of a metadata of the digital document; wherein the digital document comprises facility data related to any one or more of: facility inspection certificates, facility certificate of occupancy, facility floor plans, facility emergency procedures or facility evacuation plans.

In some embodiments, the server system processor is configured to execute the server system program instructions to: on determining that the metadata of the digital document is complete and/or valid, transmit instructions to store the digital document to the one of the one or more facility information devices; and on receiving confirmation of the storage of the digital document from the one of the one or more facility information devices, transmit to the client device a confirmation of the storage of the digital document.

Some embodiments relate to a method for performing operational assessment of a facility, the method comprising:
providing a facility information management server system comprising: a server system processor; a server system communication interface accessible by the server system processor; and a server system memory storing server system executable program instructions accessible by the server system processor;
receiving a request from a client device, the received request indicating a facility operational assessment be conducted in relation to the facility;
in response to the received request, the facility information management server system retrieving facility operational assessment data from a facility information repository database relating to the assessed facility,
determining a facility operational assessment result based on the retrieved facility operational assessment data, and
transmitting the determined facility operational assessment result to the client device.

The method for performing operational assessment of a facility further comprises:
determining whether the retrieved facility operational assessment data is sufficient to perform the requested facility operational assessment,
transmitting a request to a facility information device to retrieve further facility operational assessment data related to the assessed facility on determining the retrieved facility operational assessment data is insufficient to perform the requested facility operational assessment,
receiving the further facility operational assessment data from the facility information device from the assessed facility information device for facility operational assessment determination.

In some embodiments, the method for performing operational assessment comprises processing the retrieved facility operational assessment data and the received further facility operational assessment data by a facility operational assessment decision tree code module implemented by the server system processor based on code stored in the server system memory.

Determining the facility operational assessment result may comprise processing the retrieved facility operational assessment data and the received further facility operational assessment data by a facility operational assessment scoring module implemented by the server system processor based on code stored in the server system memory.

Facility operational assessment data may comprise one or more of: facility fire indicator panel data, facility occupant warning system data, facility lift control system data, facility water supply system data, facility smoke hazard management system data, facility active fire safety component data, facility passive fire safety component data, facility sprinkler control system data, facility electricity systems data, facility heating ventilation and air conditioning (HVAC) system data, and facility compliance standards data.

The facility operational assessment result may comprise a facility operational assessment numeric score and/or a facility operational assessment grade.

The facility operational assessment request may comprise one or more request parameters, the one or more request parameters comprising instructions to perform the facility operational assessment over a requested period of time or to perform facility operational assessment relating to a subset of facility operations.

Some embodiments relate to a facility information access system, comprising: a post or housing positioned in a location spaced from but proximate to a facility, wherein the post or housing is fixed in position and is accessible to authorised persons at ground level, wherein the post or housing defines an internal cavity and comprises an access cover to block unauthorised physical access to the internal cavity; a facility information device housed inside the post or housing and comprising: a processor; a communication interface accessible by the processor and configured to allow exchange of information with devices external of the post or housing; and a memory storing executable program instructions accessible by the processor; wherein the processor is configured to execute program instructions to: receive facility information from an external computing device or any other electronic information source through the communication interface, wherein the facility information relates to the facility; store the received facility information in the memory; receive a first request to access the facility information through the communication interface; and in response to the first request, determine whether the first request is an authorised request and, if the first request is an authorised request, transmit the facility information through the communication interface.

Some embodiments relate to a facility information access system, comprising: an in-ground housing positioned in a location spaced from but proximate to a facility, wherein the in-ground housing is fixed in position and is accessible to pedestrians at ground level, wherein the in-ground housing defines an internal cavity and comprises an access cover to block unauthorised physical access to the internal cavity; a facility information device housed inside the post and comprising: a processor; a communication interface accessible by the processor and configured to allow exchange of information with devices external of the in-ground housing; and a memory storing executable program instructions accessible by the processor; wherein the processor is configured to execute program instructions to: receive facility information from an external computing device through the communication interface, wherein the facility information relates to the facility; store the received facility information in the memory; receive a first request to access the facility information through the communication interface; and in response to the first request, determine whether the first request is an authorised request and, if the first request is an authorised request, transmit the facility information through the communication interface.

In some embodiments, a post or bollard is used to house the facility information device. In some embodiments, the post, bollard or housing may be located within the facility at a level accessible to foot traffic.

The post or housing may comprise a rigid tubular housing that defines the internal cavity, wherein the tubular housing is anchored to the ground at the location. The tubular housing may be anchored to the ground by a footing or, if the housing is within the facility or inside a building, then the housing may be anchored to a floor or wall by a suitable secure anchoring device.

The facility information device may further comprise a power supply cable to couple a mains power supply to the facility information device and a backup power supply housed inside the post or housing and coupled to the facility information device.

Some embodiments relate to a facility information access system, wherein the power supply cable extends into the housing from an aperture in the bottom of the post, wherein the aperture is positioned below ground level.

Some embodiments relate to a facility information access system, further comprising a communication cable arranged to allow communication between the communication interface and a facility monitoring system located inside the facility.

Some embodiments relate to a facility information management server system comprising: a server system processor; a server system communication interface accessible by the server system processor; and a server system memory storing server system executable program instructions accessible by the server system processor; wherein the server system processor is configured to execute the server system program instructions to: receive facility information from one or more facility information devices through the server system communication interface; store the received facility information in the server system memory; receive a second request to access facility information stored in the server system memory through the server system communication interface; and in response to the second request to access facility information, make the requested facility information available through the communication interface.

Some embodiments relate to a facility information management server system, wherein each of the one or more facility information devices is housed inside an internal cavity in a post or housing positioned in a location spaced from but proximate to a facility, wherein the post or housing is fixed in position and is accessible to pedestrians at ground level, wherein each of the one or more facility information devices comprises: a processor; a communication interface accessible by the processor and configured to allow exchange of information with devices external of the post or housing; and a memory storing executable program instructions accessible by the processor.

Some embodiments relate to a facility information management server of, wherein the processor of each of the one or more facility information devices is configured to execute program instructions to: receive facility information from an external computing device through the communication interface, wherein the facility information relates to the facility; store the received facility information in the memory; receive a first request to access the facility information through the communication interface; and in response to the first request, determine whether the first request is an authorised request and, if the first request is an authorised request, transmit the facility information through the communication interface.

Some embodiments relate to a method for managing an emergency procedure at a facility, the method comprising: a facility information device receiving a message from a facility alarm system, the received message indicating an emergency trigger; in response to the received message, the facility information device listening for: personnel entry confirmations on entry into facility by the personnel, and personnel exit conformations on exit from the facility by the personnel; wherein the personnel entry and exit confirmations include a unique identifier for the personnel.

Some embodiments relate to a method for managing an emergency procedure at a facility, the method further comprising: based on the personnel entry and exit confirmations, identifying personnel in the facility.

Some embodiments relate to a method for making facility information available to a client device, during an emergency, the method comprising: a facility information device receiving a message from a facility alarm system; determining by the facility information device whether the message relates to an emergency in the facility; in response to determining that the message from the facility alarm system relates to an emergency, the facility information device making facility information available to the client device.

The method may further comprise: in response to determining that the message from the facility alarm system relates to an emergency, the facility information device transmitting facility information to the facility information management server system.

Some embodiments relate to a method for facility compliance checking, the method comprising: a facility information device receiving a request from a client device, the message comprising a compliance check request; in response to the request, determining whether the request is an authorised request and, if the request is an authorised request, transmitting facility compliance information to the client device; storing a facility compliance check record in the memory of the facility information device.

Some embodiments relate to a method for facility information, emergency, or compliance management, wherein a facility information device is housed inside an internal cavity in a post or housing positioned in a location spaced from but proximate to a facility, wherein the post or housing is fixed in position and is accessible to pedestrians at ground level, wherein the facility information device comprises: a processor; a communication interface accessible by the processor and configured to allow exchange of information with devices external of the post; and a memory storing executable program instructions accessible by the processor.

In some embodiments, the method for performing operational assessment of further comprises: receiving by the facility information management server system, a request from the client device to store a digital document in the facility information device, the request comprising the digital document; processing by the facility information management server system, the received digital document to determine completeness and/or validity of a metadata of the digital document; wherein the digital document comprises facility data related to any one or more of: facility inspection certificates, facility occupancy certificates, facility floor plans, facility emergency procedures or facility evacuation plans.

In some embodiments, the method of performing operational assessment, further comprises on determining that the metadata of the digital document is complete and/or valid, the facility information management server system transmitting instructions to store the digital document in the facility information device; and the facility information management server system receiving confirmation of the storage of the digital document from facility information device, facility information management server system transmitting to the client device a confirmation of the storage of the digital document.

Some embodiments relate to a facility information access system, comprising: a housing positioned in an externally accessible part of a facility to securely house a facility information device; the facility information device comprising: a processor; a communication interface accessible by the processor and configured to allow exchange of information with devices external of the housing; and a memory storing executable program instructions accessible by the processor; wherein the processor is configured to execute program instructions to: receive facility information from an external computing device through the communication interface, wherein the facility information relates to the facility; store the received facility information in the memory; receive a first request to access the facility information through the communication interface; and in response to the first request, determine whether the first request is an authorised request and, if the first request is an authorised request, transmit the facility information through the communication interface.

A safety system, comprising: an electronic interface coupled to or incorporated into an emergency warning system (EWS) or occupant warning system (OWS) of a facility, the EWS or OWS comprising audible warning speakers at spaced locations in the facility; a remote command interface remote from and in communication with the electronic interface over a network; wherein the electronic interface and the remote command interface are configured to cooperate to allow the remote command interface to issue emergency alerts from the remote command interface through the EWS or OWS to occupants in the facility.

In some embodiments, the remote command interface of the safety system is configured to communicate with the facility information management server system to receive facility information; and determine an indication of occurrence of an emergency in the facility based on the received facility information and one or more predetermined thresholds relating to the facility information.

In some embodiments, the received facility information comprises facility air quality information obtained from one or more air quality sensors provided in a facility and in communication with a facility information device provide in the facility; and wherein the one or more predetermined thresholds relating to the facility information comprise thresholds relating to facility air quality information; wherein the facility information device is configured to communicate the facility air quality information to the remote command interface.

In some embodiments, the electronic interface coupled to or incorporated into an EWS or OWS of the facility is configured to communicate with a facility information device provided in a housing positioned in a location proximate to the facility, the facility information device comprising: a processor; a communication interface accessible by the processor and configured to allow exchange of information with the electronic interface and the remote command interface; and a memory storing executable program instructions accessible by the processor to configure the processor to receive emergency alerts from the remote command interface and transmit the received emergency alerts to the interface coupled to or incorporated into an EWS or OWS for broadcast OWS to occupants in the facility.

In some embodiments, the facility information device is provided in a post or in-ground housing positioned in a location spaced from the facility.

### BRIEF DESCRIPTION OF DRAWINGS

FIG. 1 is a block diagram of a facilities management system according to some embodiments;

FIG. 2 is a schematic elevation view of a facility information access system comprising a post or bollard according to some embodiments;

FIG. 3 is a block diagram showing a facility information device in communication with facility information and control systems and a client device;

FIG. 4 is a block diagram showing the facility information device in communication with the client device and a facility information management server system;

FIG. 5 is a flowchart showing some steps in the processing of messages received by the facility information device of FIG. 2;

FIG. 6 is a flowchart showing some steps performed by the facility information device of FIG. 2 to track personnel entry and exit;

FIG. 7 is a flowchart showing some steps in the process of storage of documents by the facility information device of FIG. 2;

FIG. 8 is a flowchart showing some steps performed by the facility information device of FIG. 2 in response to a compliance check request;

FIG. 9 is a flowchart showing some steps in the commissioning of the facility information device of FIG. 2.

FIG. 10 is a block diagram of a facility information management server system and database;

FIG. 11 is a flow chart showing steps performed by a facility information management server system and database in calculating a compliance assessment;

FIG. 12 is a block diagram of a facility information access system according to some embodiments;

FIG. 13 is a block diagram of an emergency command system according to some embodiments;

FIG. 14 is a screenshot of a facility compliance management user interface provided by a management server application;

FIG. 15 screenshot of a facility compliance document management user interface provided by the management server application; and

FIG. 16 is a screenshot of a facility maintenance schedule tracking user interface provided by the management server application.

### DESCRIPTION OF EMBODIMENTS

Embodiments generally relate to systems and methods for facility management. Embodiments include a facility information access system that comprises a post or a bollard or a housing. The post or bollard or housing may be permanently affixed to the ground or a permanent structure in a pedestrian accessible location, in the vicinity of a facility or within a facility. The location of the post or bollard or housing may be close to where an emergency service access point for the facility may be located. The facility information access system communicates with systems within the facility and systems outside of the facility to provide various functions including emergency management, building compliance and maintenance tracking, data collection for further analysis and intermediation between systems in the facility and systems outside of the facility.

Some embodiments relate to systems and methods for facility information management based on a facility information device or an onsite electronic tag or recording and storage device. The onsite electronic tag or device stores facility related data, serves as a back-up of information from the remote information systems and is accessible if information systems in a facility are not accessible or interrupted. This may occur in the event of an accident or natural or a manmade disaster. The facility information device also interacts with a cloud-based data storage facility that provides functions in relation to: facility operational assessment (also described herein as “facility or building health”) management and response management during an emergency.

One capability of the facility information device is to make available to an authorized person or authority with access to facility-related information and other relevant data to monitor the ongoing compliance of a facility with relevant maintenance, record-keeping and/or other legal, municipal, state or federal requirements. The facility information device also allows emergency services personnel access to all relevant facility information such as; floor plans, location of internal and external firefighting equipment and Essentials Safety Manual (ESM) etc. to help emergency services personnel to provide an effective response in an emergency situation.

Facility related information from the facility information device or electronic tag and a facility information server system may be accessible through a client device configured with tailored applications, for example. The accessible facility related information includes; a building's design, compliance and maintenance records for the life of the building, live access to building information and systems including the Fire Indication Panel (FIP) and other relevant electronic building sensors, and access to telecommunication systems to communicate with the Early Warning Intercom Systems (EWIS) and Occupancy Warning Systems (OWS).

As used herein, the term “facility” is intended to include a building facility. For example, a facility in the context of the present disclosure includes built environments, such as residential buildings, commercial buildings, mixed use buildings, sports venues (e.g. stadiums, arenas), entertainment venues such as theatres or shopping malls, warehouses, or any other permanent built multiple occupancy structure for habitation or business. A facility in the context of the present disclosure also includes any of the above buildings in the process of construction or prior to occupancy.

As used herein, the term “processor” is intended to include any kind of electronic circuitry that may perform or execute instructions stored in a memory to produce a result. A processor may include one processing unit, or multiple processing units operating in parallel. A processor may include multiple processing units, each with dedicated functions, for example a signal processing unit, a graphics processing unit, an arithmetic and logical unit.

As used herein, the term “facility information” is intended to include any information relating to the configuration, status, alarms, warnings, documentation, procedures, maintenance records, or any other information in relation to the operation, management or administration of a facility. Facility information includes information automatically generated by systems within the facility as well as information produced by human input (e.g. via a client computing device) in relation to the facility.

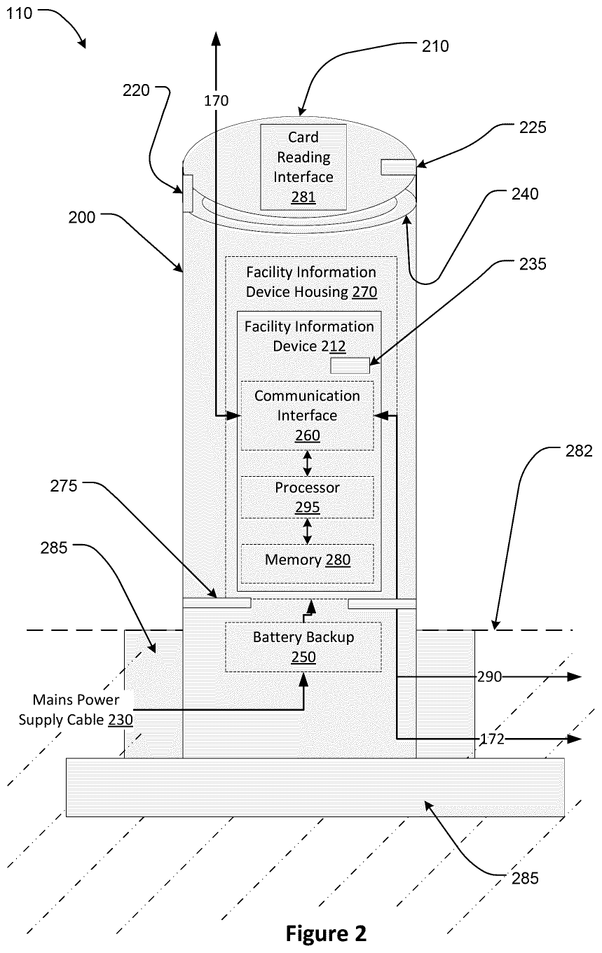

Some embodiments relate to a facility information access system 110, an example of which is shown in FIG. 2. The facility information access system 110 comprises post 200 positioned in a location spaced from but proximate to a facility 105. In some embodiments, facility information access system 100 may comprise a housing positioned in an externally accessible part of a facility as an alternative or in addition to the post 200. The post 200 may be positioned on land that forms part of the title of the land on which the facility 105 is erected. In some embodiments, the post 200 may be positioned on public land, such as on a sidewalk or margin close to a street. For example, the post 200 may be at a distance of 1 to 1.5 m away from an edge of a street adjacent to the facility. The post 200 may be fixed in position and may be accessible to pedestrians at ground level. The post 200 may define an internal cavity 270 and may comprise an access cover 210 to block unauthorised physical access to the internal cavity 270. A facility information device 212 may be housed inside the post 200. The facility information device 212 comprises: a processor 295; a communication interface 269 accessible by the processor 295 and configured to allow exchange of information with devices external of the post; and a memory 280 for storing executable program instructions accessible by the processor 295.

The processor 295 is configured to execute program instructions to receive facility information from an external computing device through the communication interface 260. The facility information relates to the facility, for example detailing structural, architectural, maintenance, operational and regulatory compliance information. The received facility information may be stored in the memory 280. The facility information device 212 may receive a request to access the facility information through the communication interface 260. In response to the first request, the facility information device 212 may determine whether the first request is an authorised request and, if the first request is an authorised request, transmit the facility information through the communication interface 260.

Some embodiments relate to facility information management server system 140. The facility information management server system 140 may comprise: a server system processor 142; a server system communication interface 148 accessible by the server system processor 142; and a server system memory 144 storing server system executable program instructions accessible by the server system processor. The memory 144 comprises program code to implement a management server application 146. The management server application 146 provides various capabilities for management of facilities including compliance and emergency management in facilities.

The server system processor 142 is configured to execute the server system program instructions to: receive facility information from one or more facility information access systems 110 through the server system communication interface 148; store the received facility information in the server system memory 144; receive a second request to access facility information stored in the server system memory 144 through the server system communication interface 148; and in response to the second request to access facility information, make the requested facility information available through the communication interface 148.

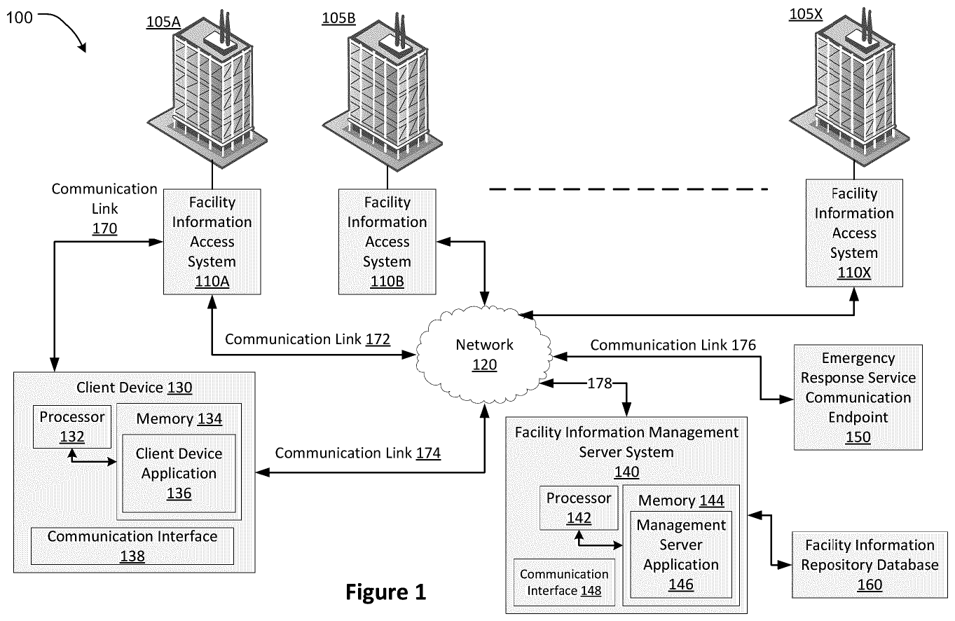

Shown in FIG. 1 is a block diagram 100 of a series of facility information access systems 110A, 110B . . . 110X in communication with a client device 130 and a facility information management server system 140 according to some embodiments. The facility information management server system 140 may comprise a single computer server or a cluster set of multiple servers. The cluster or set of servers may be formed by a group of independent servers configured to work together as a cluster to achieve the purposes described herein. Each server of the facilities information management server system 140 may be a physical server or a virtual server. The facilities information management server system 140 may be implemented using a commercial cloud computing resource or as a private server system or a combination of both.

Each of the facility information access systems 110A, 110B . . . 110X, generally referred to as facility information access system 110, are associated with a single facility 105A, 105B . . . 105X. In some embodiments, a facility 105 has a single associated facility information access system 110. That associated facility information access system 110 is physically located in relative close proximity to the facility 105 and is dedicated specifically for use in relation to only that facility 105. In some embodiments, a facility may have more than one associated facility information access system 110. In embodiments where more than one facility information access system 110 is associated with a facility 105, parts of the facility may be associated with a single facility information access system access system 110. Alternatively, the multiple facility information access system s 110 associated with a single facility 105 may operate in parallel, replicating information and functionality, and providing access from different positions. Alternatively, one facility information access system 110 may operate as a primary or designated facility information access system for the facility 105 and other facility information access systems 110 may serve as secondary facility information access systems in communication with the primary facility information access system. The secondary facility information access systems may not have a memory for storing facility information and may rely on the memory of the primary facility information access system to provide intended functionality. In any of the aforementioned embodiments, the facility information access systems 110A, 110B . . . 110X may comprise post or bollard 200 installations as depicted in FIG. 2, in-ground housing 1000 embodiments as depicted in FIG. 10, embodiments of housings internal of a facility or building, or some combination of any of those embodiments.

In some embodiments, multiple facilities 105 may be associated with a single facility information access system 110, whereby facility information relating to multiple facilities may be accessible through a single facility information access system 110. In such embodiments, the facility information access system 110 may communicate with facility information and control system 310 of multiple facilities over one or more communication links 172. Such communication links 172 may include a wireless network link, for example over a common wifi network or a wired network link, for example an Ethernet wired link.

The facility information access system 100 further comprises a series of client computing devices 130 configured to interact with the FID 110 and/or facilities information management server system 140. Each client device 130 may be a handheld computing device, such as a tablet, smartphone, or any other computing device with a display, a processor 132 and memory 134 cooperating to provide a user interface. The client device 130 may execute a client device application 136. The client device 130 also comprises a communication interface 138 enabling the exchange of data between the client device and the facility information access system 110. The communication interface 138 also enables exchange of data between the client device 130 and the facilities information management server system 140 over a network 120. The network 120 may include public and/or private subnetworks, any of which may be wired or wireless, to enable data transfer between computing devices.

The facility information access system 100 further comprises a facility information repository database 160. The facility information repository database 160 may serve as a repository to store information or data gathered by the facility information management server system 140 through the various separately located facility information access systems 110. The facility information repository database 160 may serve as a single unified source of facilities information and may make available the gathered facilities information to third parties for further analysis. The facilities information repository database 160 may be implemented as part of the facilities information management server system 140 or it may be implemented on a computer server separate from the facilities information management server system 140.

An emergency services communication endpoint 150 may be part of the facility information access system 100. The emergency services communication endpoint 150 serves the purpose of communicating to emergency services information regarding emergency triggers or alarms from one or more facilities 105.

Communication link 176 may serve to connect the network 120 to the emergency services communication endpoint 150. The communication link 176 may be a high reliability communication link, such as a dedicated wired link connecting facility information access system 110 to the emergency services communication endpoint 150. In some embodiments, the communication link 176 may link the facilities information management server system 140 to the emergency services communication endpoint 150. The emergency services communication endpoint 150 in some embodiments may lead to a call centre where the emergency trigger or alarm is received and emergency services may be alerted through the call centre operators.

In some embodiments, the emergency services communication endpoint 150 may comprise a remote command interface configured to issue emergency alerts to an Emergency Warning System (EWS) or an Occupant Warning System (OWS) or a specific facility where an emergency may have occurred. The remote command interface may allow the broadcast of messages or warnings broadcast within a facility through the EWS or an OWS provided inside the facility. The messages or warnings from the remote command interface may be intermediated by the facility information access system 110 or the facility information device of the specific facility in wired or wireless communication with the EWS or OWS provided inside a facility.

The network 120 may include, for example, at least a portion of one or more networks having one or more nodes that transmit, receive, forward, generate, buffer, store, route, switch, process, or a combination thereof, etc. one or more messages, packets, signals, some combination thereof, or so forth. The network 120 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a weightless network, a satellite network, a fiber optic network, some combination thereof, or so forth.

The communication interface 138 on the client device 130 may be implemented by one or a combination of multiple data communication technologies. The data communication technologies may include, a wired USB interface, a wired Ethernet interface, a wireless Wi-Fi interface, a wireless cellular network interface, radio-frequency identification(RFID) based interface, near field communication (NFC) based interface, a Bluetooth interface, or a weightless network interface, for example.

Communication link 170 allows the exchange of information or data between the client device 130 and the facility information access system 110. Communication link 170 may be a wired or wireless link. For example, communication link 170 may be a near field communication link, or a Bluetooth based link, or wired USB or Ethernet based link, or a weightless network link. Communication link 174 may be a wireless communication link implemented over a Wi-Fi network, a weightless network, a mobile communication network, or any other suitable technology to allow interaction between the client device 130 and the Facilities Information Management Server System 140.

The client device application 136 may be an “app” (i.e. a software application) implemented on a smartphone, such as an android app or an iOS app. The client device application 136 is configured to provide a user interface to allow a user to communicate with the facility information access system 110 or the facilities information management server system 140 or both. The communication between the client device 130 and the facility information access system 110 may include exchange of information, or instructions from the client device 130 to the facility information access system 110, for example.

The client device application 136 may be used by construction managers, building managers, building certification authorities, government or regulatory authorities, building maintenance contractors, emergency services authorities and other users to gather, update or monitor building related data. The client device application 136 may have a user authentication and authorisation module allowing the user of the client device to provide authentication credentials. The client device application 136, through its authorisation functions may present different functionalities and interfaces to different users based on their credentials and access level. For example, a building maintenance contractor may only be allowed to update building maintenance schedules and statuses. Emergency services systems or personnel may be allowed access to building evacuation plans and building emergency procedures. In some embodiments, more than one client device application 136 may be available, with each client device application 136 directed to one or more specific categories of users and/or having specific functionality tailored for interaction with a specific category of users.

The client device application 136 may allow users to interact with the various modules of the facility information management server 140 or the facility information device 212, including the compliance tracking module 332, emergency procedure module 342, facility compliance governance module 422, emergency response coordination module 416, for example. The client device application 136 may allow a user to provide an input using a touch screen or a keyboard and mouse or a virtual reality or an augmented reality interface. The client device application 136 may present to a user an input interface for updating information regarding a facility. The information may comprise information regarding maintenance of one or more parts of the facility, information regarding compliance checks and outcome of compliance checks, and information regarding safety incidents, for example. On a display, such as a display screen, provided on or by the client device 130, the client device application 136 may present one or more interactive user input interfaces to allow a user to provide structured information regarding a facility that is capable of storage in the facility information repository database 160. The interactive user input interfaces may include selectable drop down lists, forms for numeric or text input, or checklists, for example. On a display provided on the client device 130, the client device application 136 may present an interface for uploading one or more digital documents or files and associated metadata relating to a compliance check or a maintenance task for a facility, for example. The client device application 136 may include an incident logging module, for example, to allow structured input of incident information relating to incidents, such as maintenance or safety or compliance incidents, occurring in relation a particular facility. Such incident information may then be accessed later by the client device application 136 of the same or another authorised client device or management server application 146, for example.

Communication link 178 connects the facilities information management server system 140 to the network 120. The communication link 178 may include a gigabit Ethernet link. The communication interface 148 may include one or more load balancers to manage and distribute incoming and outgoing communication in relation to the facilities information management server system 140.

FIG. 2 is schematic elevation view of a facility information access system 110 comprising a post or bollard 200 according to some embodiments. The post 200 may securely house the facility information device 212 to prevent it from being tampered with by unauthorised personnel or vandalised. The post 200 may be permanently affixed to the ground in the vicinity of the facility 105. For example, the post 200 may be located between about 3 metres to about 20 metres from an external wall or structure of the facility. Anchoring means 285 secures the post 200 to the ground. Anchoring means 285, may include a concrete foundation or some form of metallic anchoring, for example. The post 200 may be positioned in a reasonably publicly accessible area near the facility 105. The location of the post 200 may allow easy access at a pedestrian level for an individual carrying the client device 130.

The post 200 may also protect the facility information device 212 from heat, humidity, cold or other weather elements. The post 200 may comprise a surrounding metal tube or sheet 240 of thickness ranging from 5 mm to 25 mm, or from 10 mm to 20 mm, for example. The post 200 may secure the facility information device 212 from external impact, for example, an impact resulting from vehicles being driven into the post 200. The post 200 may be of a height of 80 cm to 160 cm above ground surface 282, for example.

The post 200 comprises a cover or closure hatch 210 providing access to a facility information device housing 270. The cover or closure hatch 210 is secured to the post 200 by one or more hinges 220 or other securing elements. The cover or closure hatch 210 is secured by a locking mechanism 225. The locking mechanism 225 may be a physical key driven lock, or an electronic lock or a combination of a physical and electronic lock. Part of the post 200 may also serve as a portal for reading information from identification cards or devices through a card reading interface 281. The card reading interface 281 conveys signals to the facility information device 212 through a communication interface 260. The card reading interface 281 may be a NFC interface or a swipe card interface, for example. The card reading interface 281 may be configured to also interact with a mobile device to read information from the mobile device, for example for identification or authentication purposes.

In some embodiments, as an addition or an alternative, a card reading interface 281 may be located on a fixture remote from the post 200, for example at a location external to the facility but proximate to a firefighting fixture, such as a fire hose cupboard or cabinet. When the card reading interface 281 is positioned remote from the post 200, the card reading interface is configured to communicate with the facility information device 212 through a wired or wireless communication link to convey information, for example through a wifi network link, or through an Ethernet or USB link.

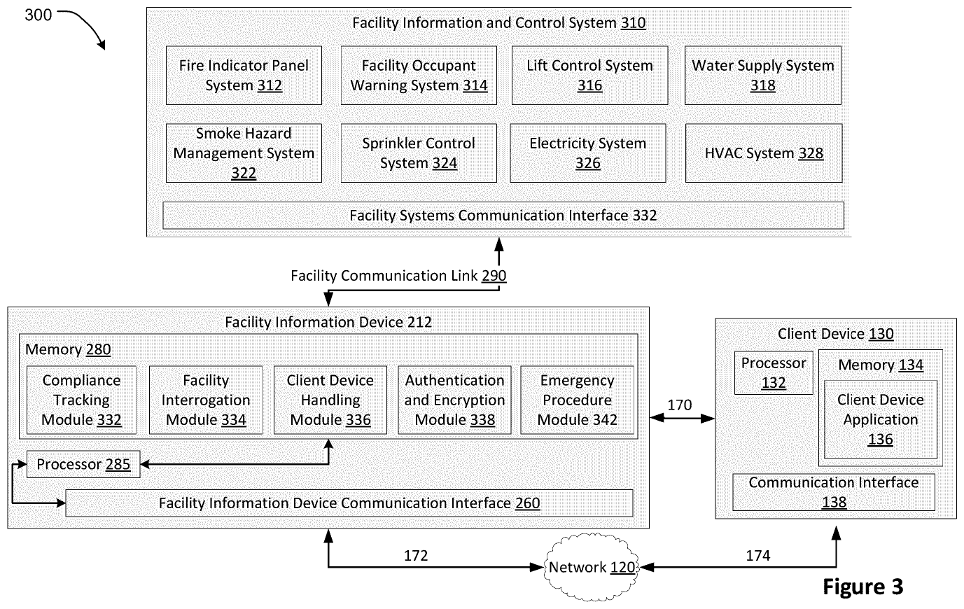

The facility information device housing 270 securely houses the facility information device 212 while allowing access to connect to peripherals such as a mains power supply 230, communication links 290, 172 and 170. Communication link 290 connects the facility information device 212 with facility information and control system 310 (shown in FIG. 3).

The facility information device 212 comprises a processor 295 to execute instructions stored in a memory 280. The memory 280 may comprise non-volatile storage of 10 GB to 1000 GB, for example.

The facility information device housing 270 comprises a stand or frame 275 to support the facility information device 212 after it is received in the cavity. The post 200 may also include one or more exposed data access ports 235 to allow a wired connection to the facility information device 212. The exposed data access ports 235 may be USB ports or Ethernet ports or any other ports that may facilitate exchange of information with the facility information device 212.

The communication interface 260 allows the facility information device 212 to communicate with client device 130 over the communication link 170. The communication interface 260 allows the facility information device 212 to communicate with facilities information management server system 140 over the communication link 172 through the network 120. The communication interface 260 may comprise a suitable antenna to facilitate transmission and reception of signals. The communication interface 260 may also comprise components to receive a SIM card to facilitate communication through 2G, GSM, EDGE, CDMA, EVDO, 3G, GPRS, 4G, 5G or other suitable telecommunication networks.

The post 200 may be connected to mains power through the mains power supply 230. The post 200 may also comprise an internal battery backup 250 to enable continuous operation of the facility information device 212 in the event of failure of mains power supply 230. In some embodiments, the mains power supply 230 may be conveyed from the facility 105.

In some embodiments, the facility information access system 110 contains the facility information device 212 in a secure housing instead of the post 200. The secure housing may house all the physical components of the facility information access system 110. The secure housing may be located in a readily accessible external part or vicinity of the facility 105, for example near a fire hose cupboard or cabinet. The secure housing may be located within about 3 metres from the fire hose cabinet, for example. In some embodiments, the secure housing may be bolted onto or positioned in close proximity (e.g. within 3 metres) to the fire hose cupboard.

FIG. 3 is a block diagram showing the facility information device 212 in communication with facility information and control systems 310 and the client device 130. Facility information and control system 310 includes the various subsystems within the facility 105 to keep track of the status of the various infrastructure components, warning systems, and control systems within the facility 105.

A fire indicator panel (FIP) system 312 receives information from devices within the facility that detect and report fires or potential fires, monitors the progression of a fire over various spaces within the facility and transmits information necessary to prepare for firefighting and rescue activities. The FIP system 312 may also control the supply of electrical energy to operate any fire alert or warning systems. The FIP system may 312 may transmit a fire trigger signal to the facility information device 212. The FIP system 312, after transmitting a fire trigger signal may transmit the location of the fire. As the location of fire changes or as the fire progresses, the FIP system 312 may transmit an updated alert or warning signal.

A facility occupant warning system 314 comprises sound systems and an intercom system for the purpose of alerting occupants during a perceived or an actual emergency. The facility occupant warning system 314 may communicate with the FIP system 312. The facility occupant warning system 314 may transmit signals or messages to the facility information device 212 regarding fire drills conducted using the facility occupant warning system 314, including the date, time and duration of such fire drills.

Lift control system 316 controls the operation of lifts in the facility 105. The lift control system 316 may transmit signals or messages to the facility information device 212 regarding the operation of the lifts. The information regarding the operation of the lifts may include logs of movement of each lift over a period of time, estimated occupancy of lifts, periods of breakdown of lifts and other similar information. During emergencies, the lift control system 316 may transmit the location of lifts with occupants where a rescue may be necessary through the facility systems communication interface 332.

Water supply system 318 and electricity system 326 control the supply of water and electricity within the facility 105. The water supply system 318 and electricity system 326 may transmit signals or messages to the facility information device 212 regarding the operational status of water supply and electricity to the various parts of the facility 105 through the facility systems communication interface 332.

Smoke hazard management system 322 controls smoke and heat vents in the facility 105 to control, to the extent possible fire and smoke within the facility 105 in an emergency to allow sufficient evacuation time for the occupants. The smoke and hazard management system 322 during an emergency may transmit signals or messages to the facility information device 212 regarding the operation of smoke and heat vents in the building, and information regarding estimated time available for evacuation through the facility systems communication interface 332. During non-emergency conditions, the smoke and hazard management system 322 may transmit signals or messages to the facility information device 212 regarding the operational conditions on individual smoke and heat vents and any warning associated with individual smoke and heat vents through the facility systems communication interface 332.

The sprinkler control system 324 controls and monitors the operation of sprinklers within the facility 105. During an emergency, the sprinkler control system 324 may transmit signals or messages to the facility information device 212 regarding the operation of individual sprinklers through the facility systems communication interface 332.

The heating, ventilation, and air conditioning (HVAC) system 328 controls the various components in the facility that provide heating, ventilation or air-conditioning. The HVAC system 328 may transmit signals or messages to the facility information device 212 regarding the operation condition of each component of the facility 105's HVAC systems through the facility systems communication interface 332. The operational conditions may include any specific configuration of the components and any warnings generated by the components.

The facility information and control system 310 includes a facility systems communication interface 332 that facilitates the transmission and reception of data and instructions from and to the facility information device 212 over the facility communication link 350. The facility communication link 350 may be a wired or wireless communication link with a range sufficient to cover the area where the post 200 is positioned. The facility systems communication interface 332 may comprise one or more transceivers that receive signals from the various facility information and control systems and communicate the received signal to the facility information device 212. The facility systems communication interface 332 may also allow the querying of specific facility information and control systems 310 by the facility information device 212. The facility systems communication interface 332 may implement an appropriate data communication protocol to manage communication across the various components of the facility information and control systems 310.

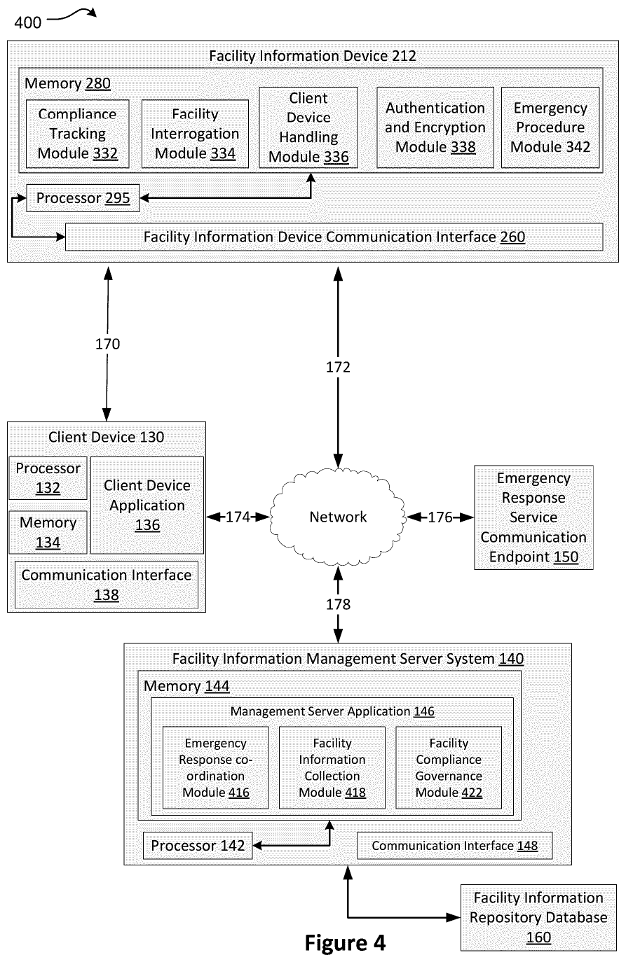

FIG. 4 is a block diagram 400 showing the facility information device 212 in communication with the client device 130 and the facility information management server system 140. The facility information management server system 140 comprises software modules to provide the various functions performed by the facility information management server system 140. An emergency response co-ordination module 416 manages and co-ordinates responses to emergency triggers or alarms in one or more facility 105. In the event of an emergency in a facility 105, the emergency response co-ordination module 416 may receive a message intermediated through the facility information device 212.

A facility information collection module 418 may periodically query facility information device 212 to request for any updated information or new records or documents stored in the facility information device 212. The collected records, documents or information may be stored in the facility information repository database 160.

A facility compliance governance module 422 may assess the facility related records, documents or information stored in the facility information repository database 160 to determine if a facility is meeting mandated compliance or regulatory requirements, identify any failures in meeting the compliance or regulatory requirements, and report the identified failures to client device 130.

The emergency response co-ordination module 416, facility information collection module 418 and facility compliance governance module 422 form part of the management server application 146. In some embodiments, the management server application 146 may comprise a web application providing an interactive web interface to enable a user to remotely interact with the various modules of the management server application 146 using the client device 130.

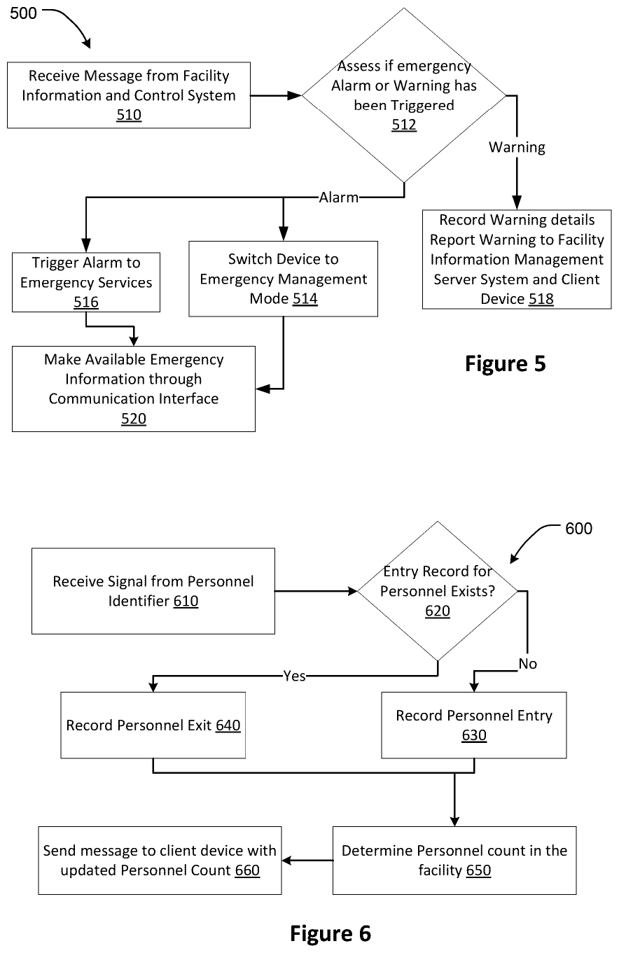

FIG. 5 is a flowchart 500 showing some steps in the processing of messages received by the facility information device 212. Step 510 comprises, the facility information device 212 receiving a message from the facility information and control system 310 through the facility communication link 290. The received message may comprise identification of the source or origin of the message, the nature of the message, whether it is a warning or an alarm, and further details regarding the warning or alarm. In some embodiments, the message comprises information regarding an operational status of the facility information and control system 310.

At step 512, the facility information device 212 determines whether the received message relates to an emergency or a warning. If the message relates to a warning, the facility information device 212 records the details of the warning message in its memory 280 and communicates the details of the warning to the facility information management server 140 and optionally also a client device 130.

If at step 512 the facility information device 212 determines that the message relates to an alarm, then steps 516 and 514 are executed in parallel by the facility information device 212. Step 516 comprises triggering an alarm through the communication link 176 to the emergency response service communication endpoint 150. Step 514 comprises switching the facility information device 212 to an emergency management mode. Subsequently, at step 520 emergency related facility information is made available to client device 130 through the communication interface 260 over the communication link 170. Additionally, the emergency related facility information may also be made available to the client device 130 through the facility information management server 140 over the network 120. This may provide advance access to the emergency related facility information via the client device 130 to emergency services while emergency services personnel are in transit, enabling advance planning of emergency response activities and rescue operations before arrival at the facility 105.

The emergency related facility information may comprise fire management plans, evacuation plans, structural information regarding the facility and other information necessary for emergency services. Making available emergency related facility information through the post 200 allows the avoidance of risks associated with entering a facility during an emergency to gain further information.

The Emergency Information Device Communication Interface 260 may also allow emergency services personnel to communicate with the Facility Information and Control System 310 through to the Facility Occupancy Warning System 314. Communication to the Facility Occupancy Warning System 314 may allow emergency service personnel to communicate with occupants within a facility and provide direction for evacuation or direction as to movement within a facility.

Some embodiments relate to an emergency command system 1300 illustrated in FIG. 13. The emergency command system 1300 comprises: an occupant warning system (OWS) communication interface 1310 forming part of the facility information and control system 310. The OWS may be coupled to or incorporated into an emergency warning system (EWS) or facility occupant warning system (OWS) 314 of the facility. The EWS or OWS 314 comprises audible warning speakers at spaced locations in the facility that can emit speech warning and warning sounds, as well as general alerts.

The emergency command system 1300 further comprises a remote command interface remote from and the facility information and control system 310 and in communication with the OWS communication interface 1310 over the network 120. The remote command interface may be in the form of a client computing device 1330. The client computing device 1330 comprises an audio input output interface 1320 which allows communication of audio signals to and from the facility occupant warning system 314. The client device 1330 may be based in or part of an operational command centre, such as an emergency assistance centre, or it may be accessible from or form part of a municipal operations centre, to allow a coordinated emergency response action in addition to or instead of emergency response actions taken by responsible personnel on site at the place of the emergency.

The OWS communication interface 1310 and the remote command interface are configured to cooperate to allow the computing device 1330 to issue emergency alerts from the remote command interface through the EWS to occupants in the facility. The OWS communication interface 1310 may a microcontroller or a system on chip or an integrated circuit that is configured with the necessary hardware and/or software to facilitate the communication of signals (including voice signals) between the fire indicator panel 312 and the facility occupant warning system 314.

FIG. 6 is a flowchart 600 showing some steps performed by the facility information device 212 to track personnel entry and exit. At step 610, a personnel may present their card on the card reading interface 281 on post 200. The facility information device 212 receives a message from the card reading interface 281, the message includes a unique identifier identifying the personnel who had presented their card. At step 620, the facility information device 212 determines if a previous entry record exists for the personnel who had presented their card at step 610. If a previous entry record exists for the personnel, then at step 640, an exit event is recorded for the personnel. If a previous entry record does not exist for the personnel, then at step 630, an entry event is recorded for the personnel.

At step 650, the recorded entry and exit events are used by the facility information device 212 to determine the number and identity of personnel in the facility. At 660, the determined number and identity of personnel in the facility is communicated to a client device 130.

Flowchart 600 may be relied on during an emergency procedure to keep track of emergency response personnel entering and exiting the facility 105. The availability of information about the number of personnel in the facility may enable assessment of emergency rescue efforts or may allow accounting for missing personnel during an emergency. The availability of this information through post 200 enables planning and control of an emergency response outside the facility 105 but from an accessible vicinity of the facility 105.

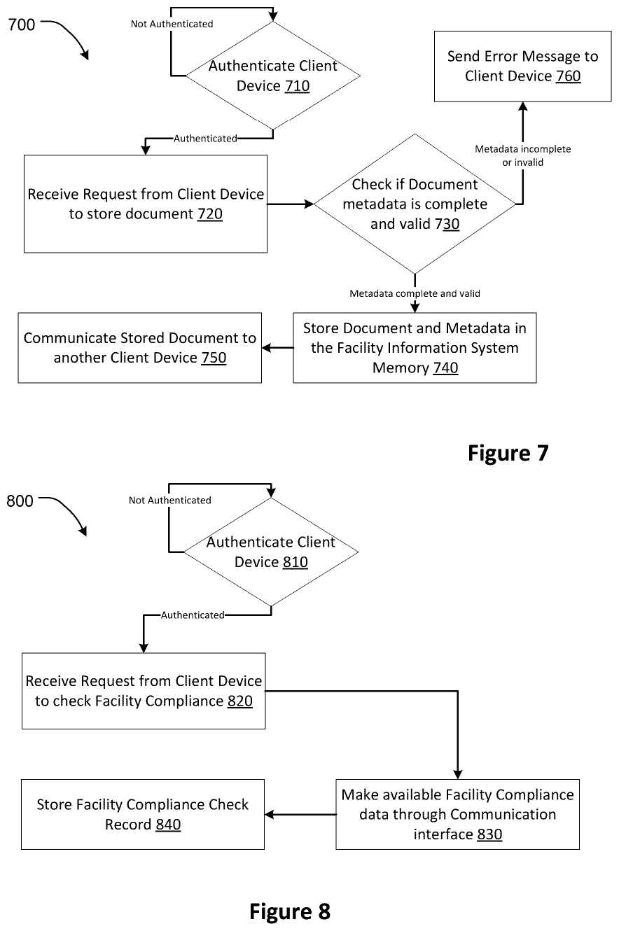

FIG. 7 is a flowchart 700 showing some steps in the process of storage of documents by the facility information device 212. Step 710 comprises authentication of the client device 130 by the facility information device 212. The authentication may occur through the communication 170, or through the card reading interface 281. If the client device is authenticated, at step 720, the facility information device 212 receives a request from the client device 130 to store a document. The request may comprise the document and any associated document metadata. The document metadata may include, for example, the nature, issuing authority or version of the document. At step 730, the facility information device 212 checks if the document metadata is complete and valid according to a predetermined set of validation rules stored in the memory 280. If the document metadata is incomplete or invalid, then at step 760 the facility information device 212 sends an error message to the client device 130. The error message may include the details of the invalid or incomplete document metadata.

If the document metadata is complete and valid, at step 740, the facility information access system 212 stores the received document and the document metadata in its memory 280. At step 750, the facility information access system 212 may communicate the stored document in response to a request for the document from another client device 130. The flowchart 700 may be implemented to store and retrieve documentation in relation to the building, such as inspection certificates, certificates of occupancy, certification regarding updates or changes to floor plans, emergency procedures and evacuation plans, for example.

FIG. 8 is a flowchart 800 showing some steps performed by the facility information device 212 in response to a compliance check request. A representative of a facility inspection authority may be authorised to conduct compliance checks using the facility information device 212. At step 810, a client device 130 may authenticate itself as an inspecting authority. At step 820, the facility information device may receive a facility compliance check request from the client device 130. In response to the request at step 820, the facility information device 212 may make available facility compliance data and any other related documents or data through the communication interface 260. The client device 130 may access the facility compliance data to make an assessment regarding whether the facility is compliant. At step 840, the facility information device 212 may record the occurrence of the compliance check along with a time stamp, details of the client device 130 and any other relevant details regarding the compliance check.

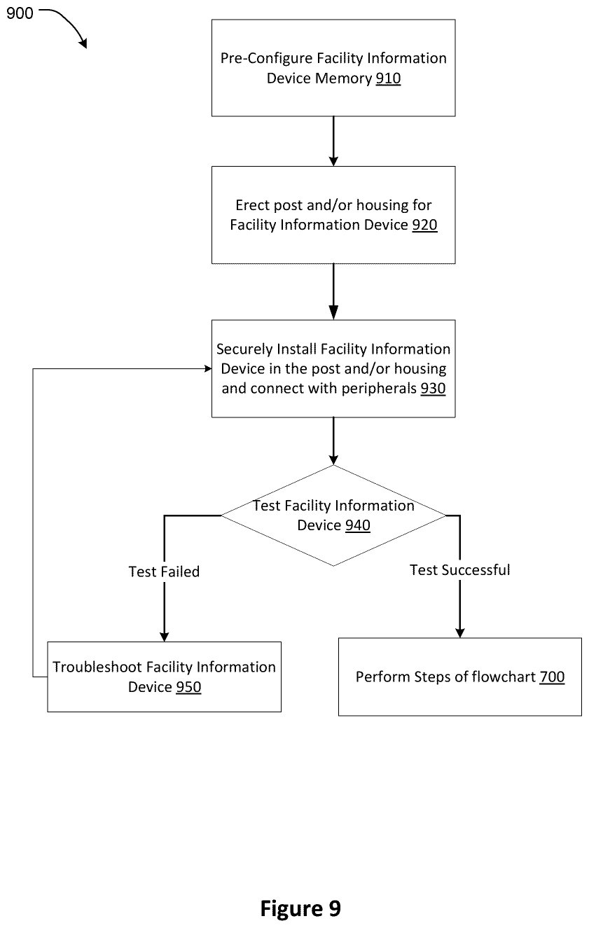

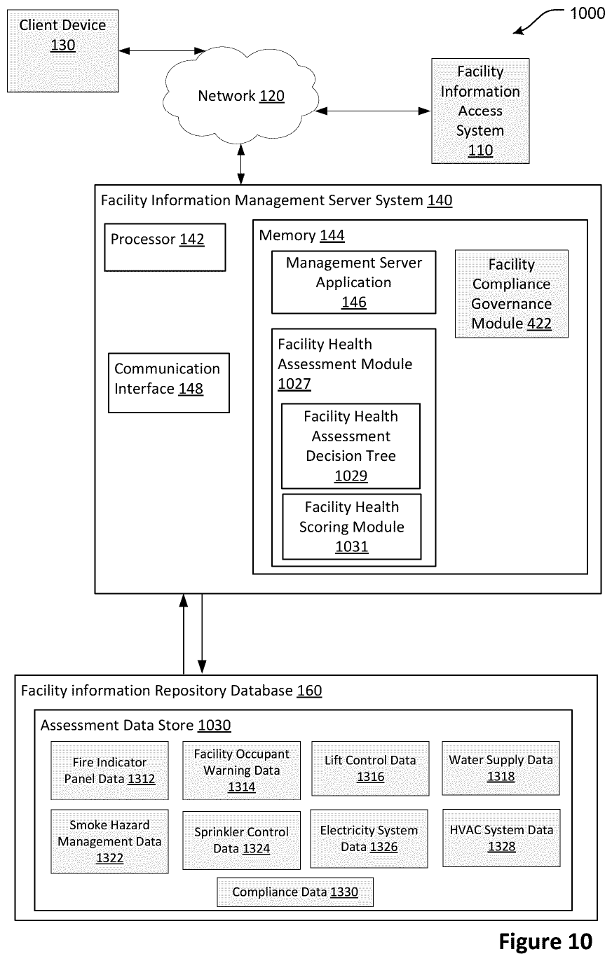

FIG. 9 is flowchart 900 showing some steps in the commissioning of the facility information device 212. Step 910 comprises pre-configuring the memory 280 of the facility information device with the necessary operating system, software modules, authentication and authorisation related information, communication protocols, device drivers and any other necessary software dependencies. At step 920, the post 200 is erected in an accessible location in proximity to the facility. The erection may include securing the post 200 in the anchoring means 285. The erecting includes ensuring the necessary peripherals like mains power supply cable 230, communication links 290 and 172 are accessible from within the housing 270. At step 930, the facility information device pre-configured at step 910 is securely installed in the housing 270 in the post 200 and it is connected to the peripherals. At step 940, a test to assess readiness of the facility information device 212 is conducted by a client device 130. The test may comprise accessing a pre-configured test data. If the test is successful, steps of flowchart 700 may be performed by the facility information device 212. If the test is unsuccessful, some troubleshooting may be undertaken at step 950, followed by subsequent tests.

FIG. 10 is a block diagram of a facility operational assessment system 1000. System 1000 comprises a facility information management server system 140 as previously described with references to FIGS. 1 and 4, facility information repository database 160, network 120, and facility information access system 110 as previously described with reference to FIGS. 1 and 2. The facility information management server system 140 comprises a facility operational (“health”) assessment module 1027. The facility operational assessment module 1027 comprises executable program code to perform an operational assessment determination or calculation for a particular facility based on information made available through the facility information access system 110. The executable program code includes a facility operational assessment decision tree 1029 and a facility operational scoring module 1031.

The facility operational assessment decision tree 1029 comprises program code to implement a decision tree that receives as input facility data from the facility information access system. The facility data may comprise data from a fire indicator panel system 312. The fire indicator panel system 312 may comprise data relating to active fire safety components or passive fire safety components. Active fire safety components comprise components in a facility that actively extinguish a suspected fire by relying on components such as the sprinkler control system 324. Passive fire safety components include fire resistance rated facility components such as walls, fire safety door or floors that passively retard the spread of fire within a facility. Facility active fire safety component data may include data relating to the operation status, maintenance history or position of active fire safety components within a facility, for example. Facility passive fire safety component data may comprise data relating to the location and grade of passive fire safety components within the facility, for example. The facility operational assessment decision tree 1029 may produce as output an operational assessment grade, class or category based on the facility data. The grade, class or category may include: red, yellow or green, for example. A red grade may reflect serious safety issues or concerns that need immediate action, a yellow grade may indicate significant issues but no serious safety issues and a green grade may indicate no significant issues with a facility, for example. The grade, class or category may allow an intuitive and easily accessible representation of the operational “health” status of a facility despite the large amount of complex information that may go into the determination of the facility's grade, class or category.

The facility scoring module 1031 comprises executable program code modules to determine a facility operational health score or rating based on facility data received from the facility information access system 110. The facility operational health score may be over a scale of 1 to 10 or 1 to 100, for example. The determination of facility operational health score may be based on weighted calculations with facility data as input, for example. The facility scoring module 1031 enables the factoring of a significant number of complex variables to determine an intuitive assessment of the overall operational health of a facility. The determined scores also enable efficient comparison of facilities with respect to the overall safety and operational standards. In some embodiments, the facility operational assessment decision tree 1029 may rely on the facility scoring module to perform part of the facility operational grade determination. The determined facility grade, class, category or score may be based on facility data over a period of time, for example over a week, or over a month or over a year.

The facility operational assessment module 1027 may receive data from an assessment data store 1030 and perform analysis based on the data, producing a compliance rating against optimum or expected thresholds. These ratings may then be further compiled and analysed by governance module 422 as described with reference to FIG. 4. The determined facility operational health rating, score, grade, class or category representative of an overall facility operational health assessment may be transmitted to client devices 130 or the facility information access systems 110. The overall facility assessment may provide a simplified view of the facility's compliance to regulatory standards and overall health and safety. Accordingly, the facility assessment can serve as an indication of risk to the facility or its operations. In some embodiments, this assessment is a single score, a percentage, a colour or numerical ranking, or some other visual representation. In other embodiments, a plurality of scores are provided with respect to the different areas of operation separately determined by the facility scoring module 1031.

An assessment data store 1030 may be incorporated within repository database 160. The information stored within the data store 1030 may comprise, for example: Fire Indicator Panel Data 1312, Facility Occupant Warning System Data 1314, Lift Control System Data 1316, Water Supply System Data 1318, Smoke Hazard Management System Data 1322, Sprinkler Control System Data 1324, Electricity System Data 1326, HVAC System Data 1328, and/or Compliance Data 1330. Compliance data 1330 stored in the data store 1030 may comprise regulatory compliance information relating to the ongoing operation and functions of the related facility 105.

The information stored within data store 1030 may be supplied by client device 130, facility information access systems 110, fire indicator panel (FIP) systems 312 having appropriate network uplink capability, or other appropriate means. The data within assessment data store 1030 may be selectively downloaded into memory 144 by the processor 142 to make the data available to data to the facility operational assessment module 1027.

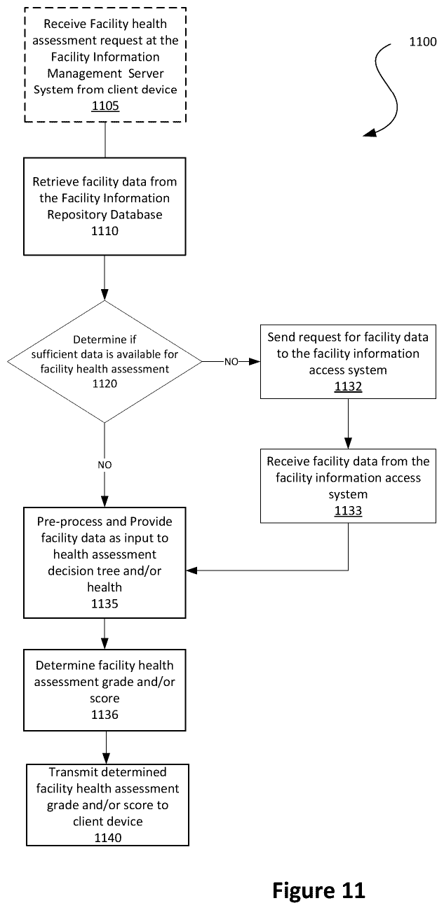

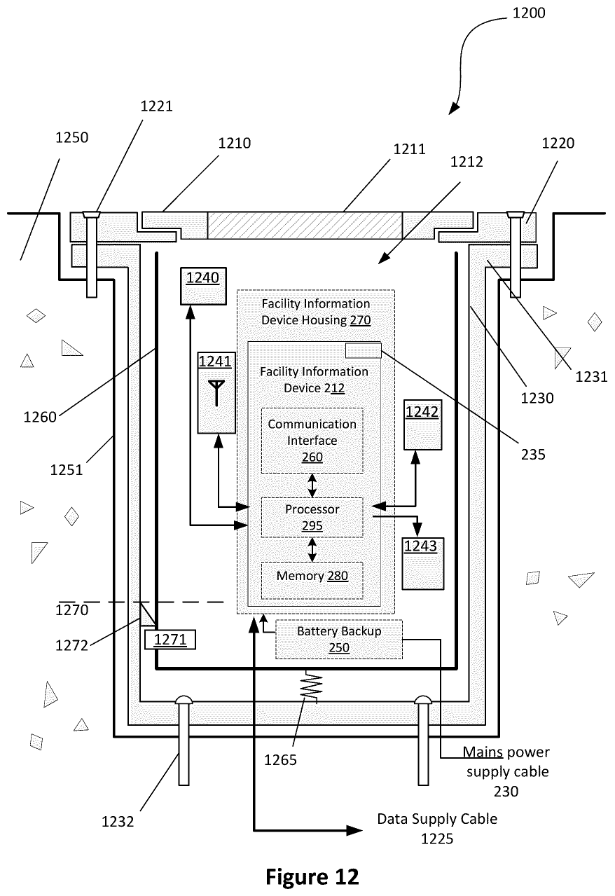

FIG. 11 is a flowchart 1100 of a process or method of facility operational assessment capable of being executed by the Facility operational Assessment Module 1027. At step 1105, a request to perform facility operational assessment is received by the facility information management server system 140. In some embodiments, the request is issued or originates from the client device 130. In other embodiments the request may issue or originate from the facility information access system 110. In other embodiments, the step 1105 may not be performed and the process 1100 may be initiated by the facility information management server system 140 according to a pre-defined schedule, for example on a daily, weekly, monthly or yearly basis. The received request at step 1105 may comprise request parameters. The request parameters may include a period of time over which the operational assessment determination is to occur or a subset of facility health aspects that the operational assessment is to be limited to, for example.

At 1110 processor 142 executing the facility operational assessment module 1027 retrieves data from the assessment data store 1030 to perform the operational assessment according to the received request. At 1120 the facility operational assessment module 1027 determines whether it has access to sufficient data to complete a facility operational assessment based on the data retrieved from the Assessment Data Store 1030. This check may comprise identification of whether required information is absent, out of date, or otherwise unavailable. If the facility operational assessment module 1027 determines an absence of sufficient data, then at step 1132 the facility operational assessment module 1027 transmits a request to the facility information access system 110 of the relevant facility requesting for data necessary to perform the operational assessment. At step 1133 the Facility Information Management Server System 140 receives information from the facility information access system 110 in response to the request transmitted at step 1132. The received data may be stored in the Assessment Data Store 1030 for future operations.

If critical data or data sufficient to perform the operational assessment is available to the facility operational assessment module 1027, then the processes continues at step 1135. At step 1135, the facility operational assessment module 1027 gathers the facility related data from the assessment data store 1030. The facility operational assessment module 1027 may pre-process the facility data received from the various components of the facility information and control system 310 in a format suitable for performing operations of the data to determine a facility health assessment score. At step 1136, the facility operational assessment module 1027 performs an analysis based on the data stored in the assessment data store 1030 to provide a compliance rating, grade, score or class to the particular facility. In some embodiments, this analysis may comprise a comparison of received data against expected values. For the facility health assessment decision tree 1029, this may comprise providing as input to a decision tree the data stored in the assessment data store 1030. The operational assessment decision tree 1029 when executed by the processor 142, provides a facility operational assessment grade, category or class representative of the overall health or operational readiness or safety of the facility. Similarly, the facility operational scoring module 1031 may comprise one or more calculation or rating models that receive as input the facility data stored on the assessment data store 1030 and generate as output a facility rating or score.

The determination or assessment by the facility operational assessment decision tree 1029 or facility operational scoring module 1031 may include a comparison of frequency of inspection data of relevant systems such as smoke hazard management systems, sprinkler control systems, lift control systems, HVAC systems, a threshold comparison for consumption or number of expected/unexpected downtime events within a specified time period, for example. In some embodiments the analysis conducted may be weighted towards particular event data, providing them with a larger impact on calculated results.

At step 1140, the various operational assessment scores, ratings, grades, categories or classes determined at step 1136 are aggregated by facility operational assessment module 1207 into an overall facility operational assessment. This assessment may comprise a simplified view of a facility's utility and compliance status, and accordingly an indication of risk to the building or its operation. In some embodiments, this assessment is a single score, a percentage, a colour or numerical ranking, or some other visual representation. In other embodiments, a plurality of scores are provided with respect to the different areas of operation of the facility. After the determination or aggregation, the overall facility operational assessment is transmitted to the client device 130.

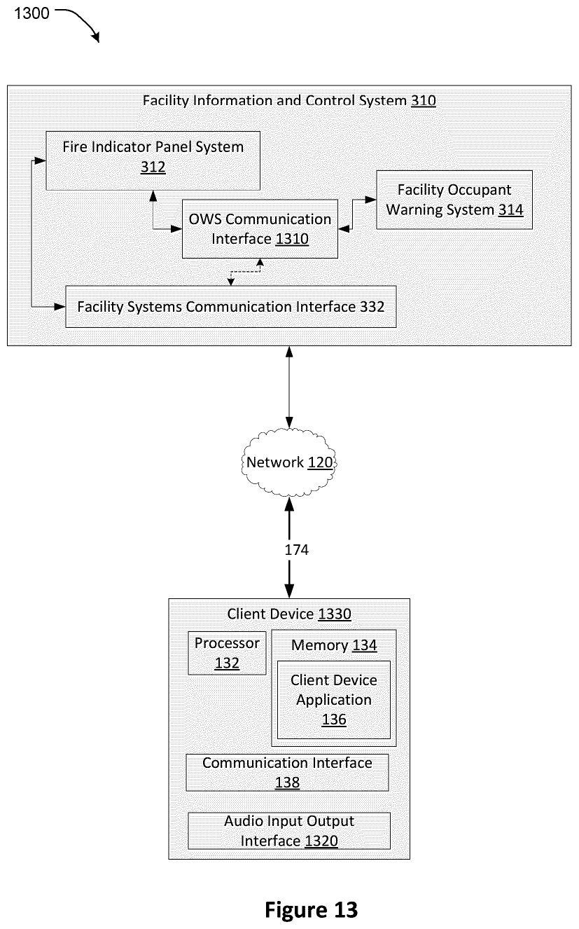

FIG. 12 is a block diagram of a facility information access system 1200 according to some embodiments. The facility information access system 1200 is installed within a recessed area 1251 within a solid medium 1250, and being physically accessible by an access hatch 1210. The facility information access system 1200 comprises a housing containing substantially the same or similar components as the system 110 described herein. The housing comprises a wall 1230 affixed within the solid medium 1250 by fixing screws 1232 and 1221, a fixing plate 1220, and an access hatch 1210. The fixing screws 1221, 1232 may comprise anti-tampering screws to limit unauthorised access and vandalism. System 1200 further comprises an inner housing 1260 within a chamber 1212 defined by the housing wall 1230, and the access hatch 1210, the inner housing 1260 containing the facility information device housing 270. The housing wall 1230 further includes an upper flange 1231 to enable securement of the upper portion of the housing wall 1230 in the solid medium 1250.

In some embodiments, the solid medium 1250 may comprise a concrete pavement, sidewalk, foundation or other solid medium accessible by foot traffic, and may comprise a pavement, floor, or other substantially ground level surface. In some embodiments, the system 1200 is installed within the solid medium 1250 within a close distance to a facility entrance. For example, the system 1200 may be installed between 1 m and 5 m or between 5 m and 50 m from a facility entrance. The beneath ground (in-ground) level installation of the embodiment of FIG. 12 may reduce potential for vandalism or damage to the facility information device from pedestrian traffic, vehicular traffic, or environmental wear.

In system 1200, the facility information device 212 is housed within an environmentally protected housing 270. The protected housing 270 is positioned in an interior chamber defined by the inner housing 1260 within the chamber wall 1230. The chamber wall 1230 may have a substantially cylindrical shape or profile with an upper flange 1231 that extends radially outward to allow fasteners 1221 to project through an aperture in the fixing plate 1220, through the flange 1231 and into the solid medium 1250.

Inner housing 1260 may be held under compression between the access hatch 1210 and an elevation element 1265. The elevation element 1265 may comprise a spring or other biasing mechanism, in some embodiments. When the access hatch 1210 is lifted, the elevation element 1265 may raise the base of the inner housing 1260 by around 10-30 cm to a level shown by line 1270, such that the top of the inner housing 1260 extends out above ground level, providing clear access to the facility information device housing 270 and data access port 235.

Power may be supplied to the device housing 270 of system 1200 by a mains power supply cable 230 to provide power to the facility information device 212 and powered components of the system 1200. In some embodiments, the mains power supply cable 230 supplies power to the system 1200 via a battery backup 250, which may store power to be used by the facility information device 212 if the mains power supply is interrupted.

In some embodiments, the inner housing 1260 may have a catch and release type mechanism with one or more latches or catch pegs 1272 provided in the housing wall 1230 to obstruct upward movement of the inner housing 1260. When the latches or catch pegs 1272 are moved so as not to obstruct upward movement of the inner housing 1260, upward movement of the inner housing 1260 may occur up to a predetermined height. A further catch or latch may be positioned higher within the wall 1230 to prevent or mitigate against over-extension of the elevation element 1265 and prevent or mitigate against withdrawal of the inner housing 1260 entirely from the within the wall 1230. An extending member 1271 may be provided to extend outward from the inner housing 1260 to catch against the catch pegs 1272, preventing over-extension of the extension element 1265. The extending member 1271 may comprise a solenoid-actuated bolt or rod, for example, or other powered catching means.

In the embodiment of FIG. 12, the facility information device 212 further includes an antenna module 1241, and optionally includes one or more of an electronic locking mechanism 1240, an air quality sensor 1242, and a ventilation module 1243. The electronic locking module 1240 may comprise an electro-magnetic lock, electronically actuated latch mechanism, or other electronic locking means to prevent or hinder unauthorised access to the facility information device 270 and/or inner housing 1260.

The antenna module 1241 may provide remote access to the facility information device 212 from client devices within the immediate vicinity. In some embodiments, the antenna module 1241 may comprise a near field communications (NFC) antenna, RFID antenna, rod or loop type antenna, or other appropriate wireless transceiver. In some embodiments, the antenna module 1241 may detect whether an electronic identification means is proximally close to the access hatch 1210, such as an RFID tag or other identifier. In such embodiments, positive detection of such an identifier (that corresponds to an authorised identifier) by the antenna module 1241 may cause the processor 295 to activate the electronic locking module 1240 to unlock the access hatch 1210, to allow access to interior components. In such an operation, processor 295 processes received data via antenna module 1241 and compares the received data to a library of authorised codes or identifiers stored in memory 280. If the received data matches an authorised identifier, the processor 295 sends a signal to unlock the locking module 1240.

Air quality sensor 1242 may be operable to detect air quality or environmental information within a vicinity of the facility information access system 1200. In some embodiments, the air quality sensor 1242 has an aperture to draw in a stream of air from the immediate environment of the system 1200 and detect one or more attributes of the air. For example, the air quality sensor may be configured to detect one or more of temperature, pollutant levels, or presence of hazardous chemicals. If an identified threshold level is met for one or more detected air quality attributes, the ventilation fan 1243 may be activated by processor 295 to evacuate air in the vicinity of the facility information access system 1200. In such an operation, memory 280 may contain a library of threshold levels for air quality attributes which the processor 295 can compare against data received from the air quality sensor 1242. If the received data from the air quality sensor 1242 exceeds, meets, or falls below stored threshold levels in the memory 280, the processor may send a control signal to activate the ventilation fan 1243 until the received data from the air quality sensor 1242 falls within acceptable threshold levels.

In some embodiments, the activation of the ventilation fan 1243 provides a cooling effect to the overall system in order to regulate temperature. In other embodiments, the ventilation fan 1243 may be activated to remove pollutants from the chamber 1212 defined by the inner housing 1260. Ventilation is provided to the system 1200 by access hatch vents 1211 comprising a series of concealed vents permitting air to enter and leave the chamber 1212.

In some embodiments, the processor 295 may determine that an air quality attribute threshold has been exceeded by comparison of stored threshold levels within memory 280 and data from the air quality sensor 1242. The processor 295 may then send a notification (indicating that the air quality threshold has been passed) from the facility information device 212 over a data supply cable 1225 to a client device 130, Facility Information Management Server System 140, or emergency response service communication endpoint 150. In other embodiments, the notification may be transmitted by antenna module 1241 or data access port 235 to a client device 130.

In such embodiments, the notification may indicate that air quality attributes in a vicinity of the system 1200 may exceed or be approaching specified threshold levels.

It will be appreciated by persons skilled in the art that numerous variations and modifications may be made to the above-described embodiments, without departing from the broad general scope of the present disclosure. The present embodiments are, therefore, to be considered in all respects as illustrative and not restrictive.

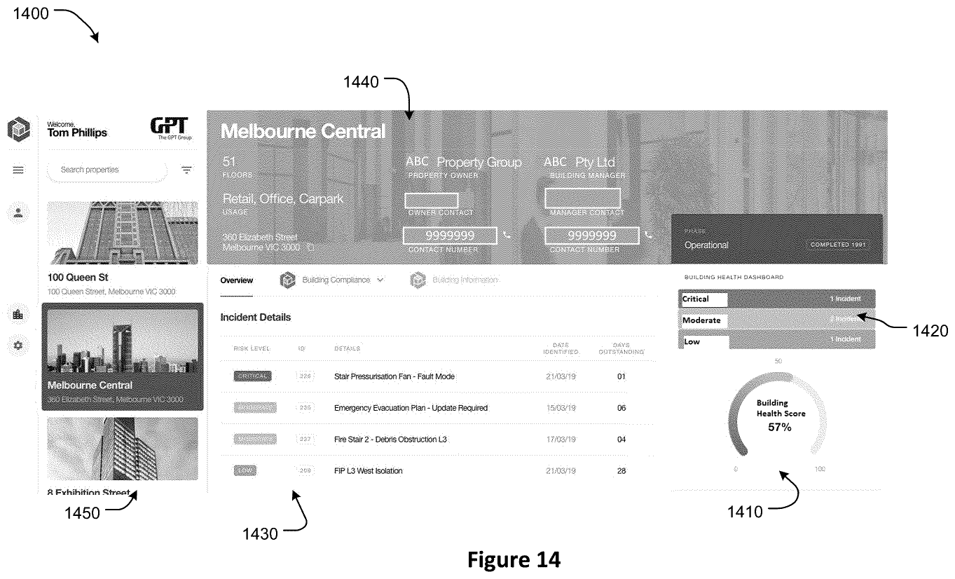

FIG. 14 illustrates a screenshot of a facility operational assessment user interface 1400 provided by the management server application 146 according to some embodiments. The user interface 1400 comprises an overall facility operational assessment score region or a facility health score region 1410. The facility health score region 1410 comprises a numeric health score and a visual indication (for example using red, yellow and green colours for different health levels) for the facility, representing the overall compliance of the facility with the relevant compliance and safety requirements. The illustrated facility health score may be calculated according to the steps illustrated in the flowchart of FIG. 11, for example. The facility operational assessment user interface 1400 comprises a facility operational incidents summary region 1420 that displays a summary of operational incidents in relation to a facility that require attention categorised by a significance level of each incident. An incident detail region 1430 in the facility operational assessment user interface 1400 displays a detailed list of recorded operational incidents in relation to a facility and additional details relating to each incident, including a significance level, a date an incident was identified and a number of days that resolution of the incident has been outstanding, for example. A facility detail overview region 1440 in the facility operational assessment user interface 1400 displays various general details associated with a facility, including a facility address, appropriate corporate and personnel contacts, and number of floors, for example. The user interface 1400 may display operational assessment data relating to multiple facilities. The user interface 1400 may thereby allow an individual or organisation responsible for managing or monitoring the operational health of multiple facilities a user interface to centrally manage oversight over multiple facilities. A specific facility from among the multiple facilities may be selected using a facility selection region 1450 to view the specific operation assessment details for the selected facility.

The management server application 146 may provide a web interface accessible to the client device 130 through a web browser. In some embodiments, where the client device 130 is a smart phone or a tablet device, the management server application 146 may be accessible to the client device 130 through a smart phone application (“app”), such as an iOS™-compatible application or an Android™-compatible application. The management server application 146 may include executable code modules such as active script modules that may be invoked by the client device 130 to generate interactive user interfaces on the client device 130 to interactively display information on the client device display and capture user input, for example via a touch interface.

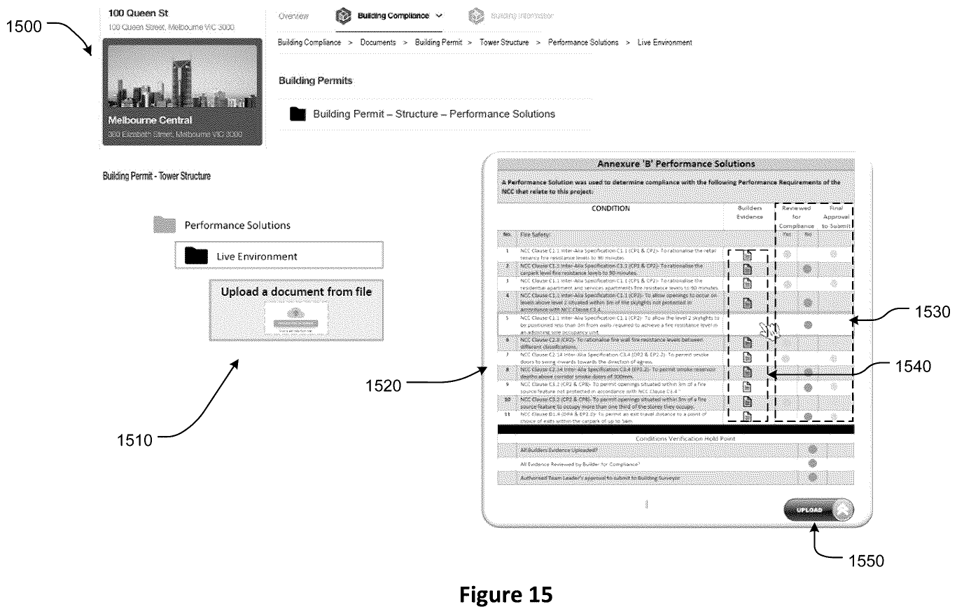

FIG. 15 illustrates a screenshot of a facility compliance document management user interface 1500 provided by the facility compliance governance module 422 of the management server application 146 according to some embodiments. The document management user interface 1500 comprises a document upload region 1510, allowing a user to select a folder structure to which a facility compliance document may be uploaded to. The document management user interface 1500 also comprises a virtual compliance document editing interface 1520 providing an interactive user interface to modify a facility compliance document. The virtual compliance document editing interface 1520 may comprise a compliance condition status management region 1530 allowing a user to manage (e.g. add or update) the status of one or more facility compliance conditions. The virtual compliance document editing interface 1520 may also comprise a compliance condition evidence linking region 1540 allowing the linking of evidence documentation with each facility compliance condition. After necessary changes are made using the virtual compliance document editing interface 1520, the updated compliance document may be uploaded using the upload button 1550.

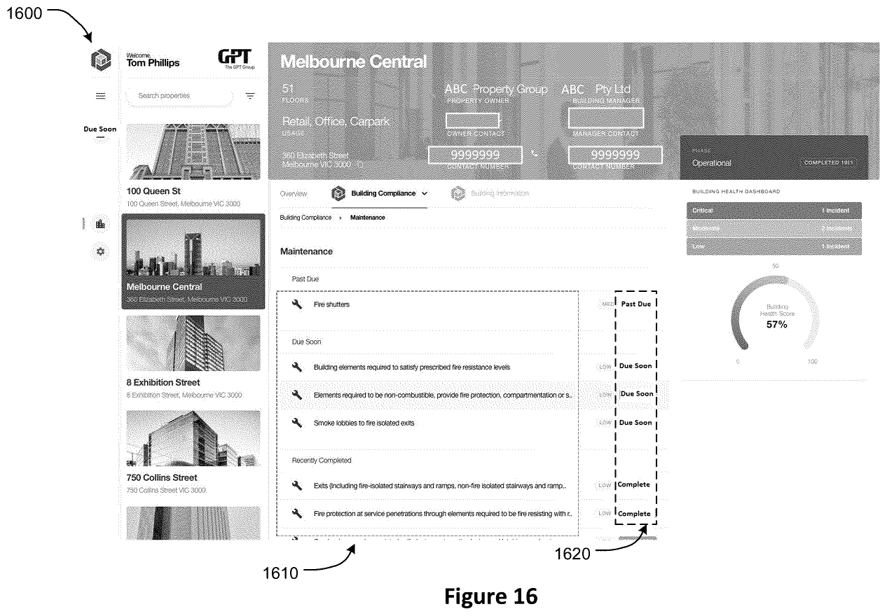

FIG. 16 is a screenshot of a facility maintenance schedule tracking user interface 1600 provided by the facility compliance governance module 422 of the management server application 146 according to some embodiments. The facility maintenance schedule tracking user interface 1600 comprises a facility maintenance items list in region 1610 and a facility maintenance item status in region 1620. The facility maintenance items may indicate specific aspects of a facility that may require maintenance according to a predetermined maintenance schedule. The facility compliance governance module 422 may determine based on the predetermined facility maintenance schedule and records relating to maintenance history of a facility in the facility information repository database 160, a list of maintenance items in relation to a facility that are overdue, or due soon or were recently performed, for example.

What is claimed is:

1. A facility information management server system comprising:
a server system processor;
a server system communication interface accessible by the server system processor; and
a server system memory storing server system executable program instructions accessible by the server system processor;
wherein the server system processor is configured to execute the server system program instructions to:
receive facility information from one or more facility information devices through the server system communication interface;
store the received facility information in the server system memory;
receive a request for operational assessment of a facility from a client device;
retrieve facility operational assessment data from a facility information repository database relating to the assessed facility;
determine a facility operational assessment result based on the retrieved facility operational assessment data, and
transmit the determined facility operational assessment result to the client device.

2. The facility information management server system of claim 1, wherein the server system processor is configured to execute the server system program instructions to:
determine whether the retrieved facility operational assessment data is sufficient to perform the requested facility operational assessment,
transmit a request to an assessed facility information device to retrieve further facility operational assessment data related to the assessed facility on determining that the retrieved facility operational assessment data is insufficient to perform the requested operational assessment,
receive the further facility operational assessment data from the assessed facility information device for facility operational assessment determination.

3. The facility information management server system of claim 2, wherein determining the facility operational assessment result comprises processing the retrieved facility operational assessment data and the received further facility operational assessment data by a facility operational assessment decision tree implemented in the server system memory.

4. The facility information management server system of claim 2, wherein determining the facility operational assessment result comprises processing the retrieved facility operational assessment data and the received further facility operational assessment data by a facility operational assessment scoring module implemented in the server system memory.

5. The facility information management server system of claim 1, wherein the facility operational assessment data comprises one or more of: facility fire indicator panel data, facility active fire safety component data, facility passive fire safety component data, facility occupant warning system data, facility lift control system data, facility water supply system data, facility smoke hazard management system data, facility sprinkler control system data, facility electricity systems data, facility heating ventilation and air conditioning (HVAC) system data, and facility compliance standards data.

6. The facility information management server system of claim 1, wherein the facility operational assessment result comprises a facility operational assessment numeric score and/or a facility operational assessment grade.

7. The facility information management server system of claim 1, wherein the facility operational assessment request comprises one or more request parameters, the one or more request parameters comprising instructions to perform the facility operational assessment over a requested period of time or to perform facility operational assessment relating to a subset of facility operations.

8. The facility information management server system of claim 1, wherein each of the one or more facility information devices is housed inside an internal cavity in a post or housing positioned in a location in or proximate to a facility to which the facility information pertains, wherein the post or housing is fixed in position and is accessible to pedestrians at ground level or ground floor level, wherein each of the one or more facility information devices comprises:
a processor;
a communication interface accessible by the processor and configured to allow exchange of information with devices external of the post or housing; and
a memory storing executable program instructions accessible by the processor.

9. The facility information management server system of claim 8, wherein the processor of the facility information device is configured to execute program instructions to:
receive facility information from an external computing device through the communication interface, wherein the facility information relates to the facility;
store the received facility information in the memory;
receive a first request to access the facility information through the communication interface; and
in response to the first request, determine whether the first request is an authorised request and, if the first request is an authorised request, transmit the facility information through the communication interface.

10. The facility information management server system of claim 1, wherein the server system processor is configured to execute the server system program instructions to:
receive a request from the client device to store a digital document in any one of the one or more facility information devices, the request comprising the digital document; and
process the received digital document to determine completeness and/or validity of a metadata of the digital document;
wherein the digital document comprises facility data related to any one or more of: facility inspection certificates, facility certificate of occupancy, facility floor plans, facility emergency procedures or facility evacuation plans.

11. The facility information management server system of claim 10 wherein the server system processor is configured to execute the server system program instructions to:
on determining that the metadata of the digital document is complete and/or valid, transmit instructions to store the digital document to the one of the one or more facility information devices; and
on receiving confirmation of the storage of the digital document from the one of the one or more facility information devices, transmit to the client device a confirmation of the storage of the digital document.

12. A method for performing operational assessment of a facility, the method comprising:
providing a facility information management server system comprising: a server system processor; a server system communication interface accessible by the server system processor; and a server system memory storing server system executable program instructions accessible by the server system processor;
receiving a request from a client device, the received request indicating a facility operational assessment be conducted in relation to the facility;
in response to the received request, the facility information management server system retrieving facility operational assessment data from a facility information repository database relating to the assessed facility;
determining a facility operational assessment result based on the retrieved facility operational assessment data; and
transmitting the determined facility operational assessment result to the client device.

13. The method of claim 12 further comprising:
determining whether the retrieved facility operational assessment data is sufficient to perform the requested facility operational assessment,
transmitting a request to a facility information device to retrieve further facility operational assessment data related to the assessed facility on determining the retrieved facility operational assessment data is insufficient to perform the requested facility operational assessment,
receiving the further facility operational assessment data from the facility information device from the assessed facility information device for facility operational assessment determination.

14. The method for performing operational assessment of claim 13, wherein determining the facility operational assessment result comprises processing the retrieved facility operational assessment data and the received further facility operational assessment data by a facility operational assessment decision tree code module implemented in the server system memory.

15. The method for performing operational assessment of claim 13, wherein determining the facility operational assessment result comprises processing the retrieved facility operational assessment data and the received further facility operational assessment data by a facility operational assessment scoring module implemented in the server system memory.

16. The method for performing operational assessment of claim 12, wherein the facility operational assessment data comprises one or more of: facility fire indicator panel data, facility active fire safety component data, facility passive fire safety component data, facility occupant warning system data, facility lift control system data, facility water supply system data, facility smoke hazard management system data, facility sprinkler control system data, facility electricity systems data, facility heating ventilation and air conditioning (HVAC) system data, and facility compliance standards data.

17. The method for performing operational assessment of claim 12, wherein the facility operational assessment result comprises a facility operational assessment numeric score and/or a facility operational assessment grade.

18. The method for performing operational assessment of claim 12, wherein the facility operational assessment request comprises one or more request parameters, the one or more request parameters comprising instructions to perform the facility operational assessment over a requested period of time or to perform facility operational assessment relating to a subset of facility operations.

19. The method for performing operational assessment of claim 12, further comprising:
receiving by the facility information management server system, a request from the client device to store a digital document in the facility information device, the request comprising the digital document;
processing by the facility information management server system, the received digital document to determine completeness and/or validity of a metadata of the digital document;
wherein the digital document comprises facility data related to any one or more of: facility inspection certificates, facility occupancy certificates, facility floor plans, facility emergency procedures or facility evacuation plans.

20. The method of claim 19, further comprising on determining that the metadata of the digital document is complete and/or valid, the facility information management server system transmitting instructions to store the digital document in the facility information device; and
the facility information management server system receiving confirmation of the storage of the digital document from facility information device,
facility information management server system transmitting to the client device a confirmation of the storage of the digital document.
